(19) United States
(12) Patent Application Publication
(10) Pub. No.: US 2005/0112243 A1
(43) Pub. Date: May 26, 2005

(54) Packaged food product

(76) Inventors: Joachim Bellmann, Hamburg (DE); Olaf Kortum, Neubiberg (DE); Michael Paton, Hertfordshire (GB)

Correspondence Address: KRAFT / FETF, 120 S. LASALLE STREET, SUITE 1600, CHICAGO, IL, 60603-3406, US

(21) Appl. No.: 10/947,964

(22) Filed: Sep. 23, 2004

(30) Foreign Application Priority Data
Sep. 29, 2003 (EP) EP 03021677.4

(51) Int. Cl. C12C 1/027

(52) U.S. Cl. 426/106

(57) ABSTRACT

A packaged food product comprises at least one low moisture component and at least one hermetically sealed high moisture component located on top of the low moisture component, the package comprising an outer shell and an inner package component which is slidably removable through a constriction in the outer shell so as to allow the high moisture component to be spread on top of the low moisture component and to constitute the uppermost component of the combined food product.

### TECHNICAL FIELD

The present invention relates to a packaged food product.

In the field of food consumption it is common that components of different moisture content are to be consumed in combination with each other. As an example, high moisture components, such as butter, spreadable cheese or the like are spread on low moisture components, such a slice of bread or a biscuit. However, it is generally unpleasant for the consumer if these two components have to be obtained separately and have to be combined before a “combined food product” consisting of the low moisture component and the high moisture component can be consumed. On the other hand, the combined food product can as such not be packaged in a single package, as the moisture from the high moisture component would migrate to the low moisture component and spoil same.

### PRIOR ART

It has been proposed in DE 19616414 C2 to provide a pouch containing a high moisture component between two halves of bread. When the combined product is to be consumed, the pouch is to be opened and pulled through a constriction opposite the opening so that the high moisture content will be spread between the halves of bread. A similar product is disclosed in DE 4216450 A1, in which the pouch has a predetermined breaking point. There is no disclosure regarding the mechanism, by means of which it is ensured that the content of the pouch is spread between the halves of bread.

DE 19946257 C2 discloses a package for containing two halves of bread and a pouch filled with a high moisture component. Specific details of the closure of the pouch are disclosed.

Finally, WO 92/18044 describes a rigid carrier comprising a high moisture component, which is sealed with a flexible film, which can be inserted in between slices of bread or a sandwich, so that the high moisture component can be delivered between the slices of bread or into the sandwich.

### SUMMARY OF THE INVENTION

The object underlying the present invention is to provide a food product, which is both securely and conveniently packaged and leads to improved consumer satisfaction.

This object is solved by means of the packaged food product described in claim 1.

The packaged food product comprises at least one low moisture component and at least one hermetically sealed high moisture component, which is located on top of the low moisture component. In order to avoid spoiling or degrading of the low moisture component, the high moisture component is hermetically sealed. This seal can be provided by an inner package component alone, or in combination with an outer shell of the package described below. In any case, water or moisture is prevented from migrating from the high moisture component to the low moisture component.

Furthermore, consumer satisfaction is enhanced by the fact that the high moisture component is located on top of the low moisture component, and not in between two halves of bread. Rather, the high moisture component constitutes the upper most component of the combined food product. This is in contrast to the prior art products, in which the high moisture component has always been an intermediate or “sandwiched” component of the combined product. This is disadvantageous as it happens frequently that the high moisture component is squeezed out of the space between the bread halves, so that the combined food product is difficult to consume or tends to spoil the hands or even clothes of the consumer. However, the present invention provides an improved combined food product which leads to consumer satisfaction as, e.g. a regular slice of bread could be provided with a high moisture component, such as spreadable cheese on top without the need of an upper most low moisture component, such as a second slice or half of bread.

By means of the invention, the special circumstances in connection with the low moisture component on the one hand and the high moisture component on the other hand, as well as the high moisture component constituting the upper most component, are taken into account as follows.

The package comprises an outer shell and an inner package component. The inner package component is slidably removable through a constriction in the outer shell. By removing the inner package component, the high moisture component is allowed to be spread on top of the low moisture component. As will be described in more detail below, the inner package component can readily be designed so as to be easily removable, so that the process of combining the high moisture component and the low moisture component with each other as well as opening the package, is facilitated. Consumer satisfaction is further enhanced by the fact that the components with different moisture contents are hermetically sealed from each other so that they are kept fresh. At the same time, the invention for the first time offers a combined food product, in which the high moisture component is the uppermost component and thus corresponds to a structure, with which the consumer is familiar and which can be consumed without the danger of spoiling due to the high moisture component being squeezed out of the space between halves or slices of bread.

Preferred embodiments of the inventive food product are described in the further claims.

Usually, the outer shell of the package stays closed, until the inner package component has been removed. In order to facilitate the opening of the outer shell and in order to gain access to the combined food product, it has been found advantageous if the outer shell comprises a hinge. In this way, a lid of the outer shell can easily be opened by a pivoting motion in order to expose the combined food product and allow easy grasping thereof.

With regard to the inner package component, it is preferred that this comprises a flexible material, in particular, a film. As will be described in more detail below, the opening of the sealed component containing the high moisture component as well as the spreading thereof can be achieved by different means. Independent from the specifics thereof, it has been found advantageous to provide the inner package component with a flexible film. Such a film can be used to squeeze the inner package component during its passage through the constriction, in order to spread the high moisture component on top of the low moisture component. Furthermore, such a flexible film can constitute an easy to remove rolling seal or can be peelable. It should be noted that the flexible material can, for example, be a metallized film, a plastic film, a foil, such as an aluminium foil or a similar material as well a combination of the mentioned materials.

The food product according to the invention can, advantageously, have a high moisture component of which the dimensions correspond to those of the low moisture component or are somewhat smaller. In this manner, a combined product offering high satisfaction for the consumer can be provided, as almost no part of the low moisture component has to remain “dry”. Rather, almost the entire or the entire low moisture component can be covered with the high moisture component. As will be detailed below, the inventive measures regarding the package allow the dimensions of the high moisture component to be the same or almost the same as those of the low moisture component.

As regards a package integrity/tamper evident feature of the packaged food product according to the invention, it is currently preferred if the package comprises at least one portion, which protects the inner package component from being accessed. In other words, in the condition for display and sale, that portion of the inner package component, which is accessible for the later removal thereof, is initially covered or otherwise protected. Thus, it is prevented that the consumer can remove the inner package component without consumption thereof, e.g. within the supermarket which would obviously destroy the product.

As mentioned above, consumer satisfaction is one of the objects underlying the invention. This is, amongst other things, affected by the convenience of removing the combined food product from the package. In this context, tests have shown that it is advantageous if the outer shell comprises at least one recess in the vicinity of the low moisture component. This recess can be adapted to allow the insertion of at least one finger in order to grip the combined food product and remove it from the outer shell.

The same effect can be obtained by that embodiment in which the outer shell comprises a hinged or at least partly removable portion, which in the hinged deflected or at least partly removed state exposes at least a part of the combined food product. At the exposed part, the combined food product can easily be removed form the outer shell.

Furthermore, in certain cases, it provides advantages to form a recess underneath the low moisture component in the outer shell that allows the low moisture component to be brought in an at least partially lifted and easy to grasp state. In other words, the area of the outer shell in which the low moisture component is contained, can comprise a recess, such as an inclined portion, so that applying pressure to the low moisture component, which now has the high moisture component on top of it, will cause tilting of the combined food product so that a portion, opposite that portion which can be accommodated in the mentioned recess, can be easily grasped.

As mentioned above, the spreading of the high moisture component on top of the low moisture component is effected after the seal of the high moisture component is broken. In this context, tests have shown good results for an embodiment in which the inner package component, which at least partly provides the seal for the high moisture component, comprises a predetermined breaking point. In particular, in combination with the constriction provided in the outer shell, this provides a superior combined food product. In contrast to the known food products, a separate opening step for opening the seal of the high moisture component can be eliminated. Rather, the seal of the high moisture component is, by means of passing at least a portion of the inner package component through the constriction, squeezed so that the predetermined breaking point is broken. Thus, without the need for opening the component containing the high moisture component, opening thereof is automatically effected and the spreading of the high moisture component on top of the low moisture component is initiated. It should be mentioned that the feature combination of a constriction in the package, particularly the outer shell thereof, through which an inner package component is removed, and a predetermined breaking point provided in the seal of the high moisture component constitutes a particularly preferred embodiment of the present invention. Furthermore, this feature combination can also be provided in a food product, in which the high moisture component is spread between halves or slices of the low moisture component.

It has, furthermore, been found advantageous to provide the inner package component with at least one rigid carrier. In particular, in connection with an embodiment, in which the constriction of the outer shell is used to squeeze the inner package component, it leads to reliable results if the inner package component comprises at least one rigid carrier. The rigid carrier can be used to delimit the space, to which the high moisture component can pass, and leads to reliable results regarding the spreading thereof.

With regard to exposing the high moisture component and allowing same to be spread on top of the low moisture component, advantages can also be obtained if the inner package component comprises at least one rolling seal. Such a seal can easily be opened if the material, e.g. a film or a foil constituting the seal, is removed, e.g. through the constriction, and thus rolled off the high moisture component. As an example, the film or foil material can be folded back upon itself and the rolling seal can be removed at the time of consumption by pulling the foil or film material in a direction away from the folded edge and substantially parallel to the surface of the material. Furthermore, a piece of material, which constitutes a rolling seal and can be “rolled off” an opening in, e.g., the inner package component containing the high moisture component, can be attached to the outer shell. When the inner package component is removed from the outer shell through the constriction, this movement will cause the rolling seal, which is attached to the outer shell, to roll off the opening, so that the high moisture component can escape through the opening. By the action of the constriction, pressure will be applied to the inner package component, when the same is moved through the constriction, and this pressure will cause the high moisture component to be squeezed through the opening and be spread on top of the low moisture component. In this context, it should be mentioned that also the feature combination of a rolling seal and a constriction constitutes a particularly preferred embodiment of the present invention and can also be provided in a food product, in which the high moisture component is spread between halves or slices of the low moisture component.

It represents a particularly advantageous and preferred embodiment of the invention when two rolling seals are used, one sealing the high moisture component and the other one sealing the low moisture component. As will be described in detail below, both rolling seals can be provided in a manner to allow them to be removed together, so that the combined food product can be obtained with simple actions to be taken by the consumer.

Generally, the shape of the at least one low moisture component is arbitrary. However, it is currently preferred for a particular embodiment to provide the low moisture component in rectangular or oval form with a thickness ranging from a few millimeters to approximately two centimeters.

As an alternative, preferred embodiment, the low moisture component has the shape of a bagel or a doughnut. For a product of this shape, it has been found that it is highly appreciated by the consumer. As mentioned above, the dimensions of the high moisture component preferably corresponds to those of the low moisture component. As the high moisture component would preferably be a soft, spreadable material, the shape thereof will correspond to that of the low moisture component in a manner to lead to a pleasing combined product.

Preferably, the low moisture component is based on dough, and/or constituted by a bread-type component, a wafer, biscuit or the like.

Finally, it is currently preferred for the high moisture component that it is a fresh or processed cheese, any kind of sandwich spread, a chocolate spread or the like.

### BRIEF DESCRIPTION OF THE DRAWINGS

In the following, the invention will be described by preferred embodiments thereof with reference to the accompanying drawings, in which:

FIG. 1 shows a schematic view of a first embodiment of the inventive food product;

FIG. 2 shows a schematic view corresponding to that of FIG. 1 of the first embodiment during spreading of the high moisture component;

FIG. 3 shows a perspective view of a second embodiment of the invention;

FIG. 4 shows a side view of a third embodiment of the invention;

FIG. 5 shows a schematic view of a part of a fourth embodiment of the invention; and

FIG. 6 shows a schematic view of a fifth embodiment of the invention.

### DETAILED DESCRIPTION OF PREFERRED EMBODIMENTS OF THE INVENTION

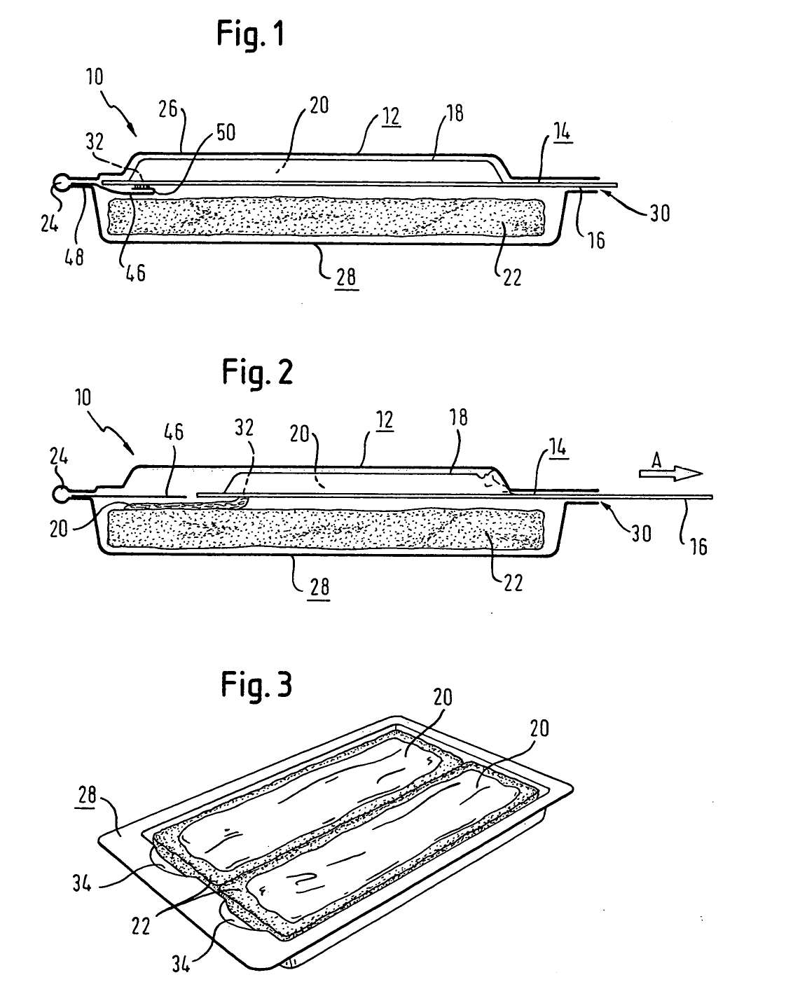

FIG. 1 shows in a schematic side view a first embodiment of the inventive packaged food product 10. The package consists of a rigid outer shell 12 and an inner package component 14. In the case shown, the inner package component 14 consists of a rigid carrier 16 and a flexible film 18 that is sealed to the rigid carrier 16 so as to hermetically seal a high moisture component 20, such as cheese, which is contained between the rigid carrier 16 and the flexible film 18 cooperating with each other. The packaged food product, furthermore, comprises a low moisture component 22, such as bread, wafer or biscuit.

The outer shell 12 can be made of plastic and can, moreover, be transparent. In the embodiment shown, the outer shell 12 comprises a hinge 24, which pivotably connects the lid 26 with a base 28. As shown, the low moisture component can be accommodated in the base 28. Furthermore, the lid 26 can provide space for the inner package component 14 containing the high moisture component 20. In the case shown, the outer shell 12 comprises a constriction 30, through which the inner package component 14, in particular the rigid carrier 16 thereof extends. Thus, the inner package component 14 is exposed for its removal by being pulled through the constriction 30 as described below. It should be mentioned, that the food product including the outer shell 12 can be packaged in an outer package (not shown), in order to protect the inner package component 14 from being accessed. As an alternative (not shown) only that portion of the inner package component, which is exposed from the constriction 30 as shown, can be protected or covered in order to prevent an inadmissible removal thereof, e.g. while the product is still on the shelf of a supermarket and not to be consumed at the moment. It should finally be mentioned that, in the depicted embodiment, the inner package component 14 comprises, preferably at an innermost position such as that denoted with reference numeral 32, an opening. This allows the contents of the inner package component to be spread on top of the low moisture component 22, when the inner package component is removed, as will be described below. For this purpose, a piece of flexible material 46, such as a foil or film material, is, on the one hand, attached to the outer shell 12 at position 48. On the other hand, this piece of material 46 is sealed to the inner package component 14, in the case shown to the rigid carrier 16 thereof, so as to constitute a rolling seal 50. This is accomplished by folding the free end of the piece of material 46 back upon itself and attaching the folded portion to the surroundings of the opening 32 in a sealed but peelable manner.

As can be seen in FIG. 2, when the inner package component 14 is pulled out of the outer shell 12, by pulling the rigid carrier 16 thereof in the direction of arrow A, the pouch or compartment, which is defined by the rigid carrier 16 in cooperation with the flexible film 18, is squeezed in the constriction 30. This applies pressure to the high moisture component 20 contained in the mentioned compartment. Furthermore, by means of the movement of the inner package component 14 in the direction of arrow A, the piece of material 46 is rolled or peeled off the opening 32, so that the opening is exposed. Thus, the high moisture component 20, such as the spreadable cheese, will flow onto the low moisture component 22 and will be spread on top of it due to the inner package component 14 being continuously pulled through the restriction 30. Thus, the entire contents between the rigid carrier 16 and the flexible film 18 can be spread on top of the low moisture component 22. At the end of the spreading process, the inner package component 14 can be pulled out of the outer shell 12 completely, the lid 26 of the outer shell 12 can be lifted and the combined food product, consisting of the high moisture component 20, spread on top of the low moisture component 22 and the low moisture component 22 as such can be removed from the package. As an alternative, the opening 32 could be replaced by a predetermined breaking point, which breaks when pressure is applied to the high moisture component 20 contained in the compartment of the inner package component, when the inner package component 14 is brought through the constriction 30. It should finally be mentioned that, as shown in FIG. 2, the piece of material 46, which constituted the rolling seal 50 (FIG. 1) remains attached to the outer shell 12 and can be disposed of therewith after removing the combined food product from the outer shell.

FIG. 3 shows in a perspective view an embodiment of the inventive product, which is similar to the above-described first embodiment. In FIG. 3 the lid is not shown. It can be seen in FIG. 3, that in this preferred embodiment two approximately rectangular pieces of the low moisture component 22, such as pieces of bread or biscuit are provided next to one another. As indicated in FIG. 3, the high moisture component 20, such as cheese, has been spread on top of both pieces. It should be mentioned that a single rigid carrier 16 can be provided on which two separate compartments containing the high moisture component are formed in order to spread same on both pieces of the low moisture component separately without filling the gap between them which would cause a messy appearance. In order to allow the high moisture component to be spread across the entire, or almost the entire, width of the low moisture component, the openings 32 or the predetermined breaking point or points in the inner package component 14 can be sized appropriately, e.g. these can have a width which pretty much corresponds to that of each piece of the low moisture component 22.

The embodiment of FIG. 3, in addition, comprises a recess 34 formed in the vicinity of one of the small sides of each of the pieces of the low moisture component 22. In the case shown, the recess 34 is approximately semicircular in the plan view. The recess 34 allows the insertion of a finger around the adjacent short side or even underneath the low moisture component 22 in order to facilitate the removal thereof from the base 28. It should be mentioned that the recess 34 can have a different shape and/or different position. Thus, one or more recesses can be provided adjacent one or both long sides of the rectangular low moisture component 22 at any suitable position along the length thereof, in order to allow gripping along the long sides. Furthermore, the two pieces of low moisture component 22 can be provided aligned with each other rather than adjacent to each other, and a single recess can be provided in the vicinity of their short sides lying next to each other, at one or both long sides thereof in order to allow easy removal of either a piece of the low moisture component. Finally, the shape of the base, in particular the shape of the indentation formed therein can be formed somewhat bigger than the size of the one or more pieces of low moisture component contained in the base. Thus, that part of the indentation, which is not covered with pieces of low moisture component, can be used to insert one or more fingers so as to grip the pieces. FIG. 3 shows a state in which the high moisture component 20 has been spread on top of pieces of bread 22, and a lid has been removed.

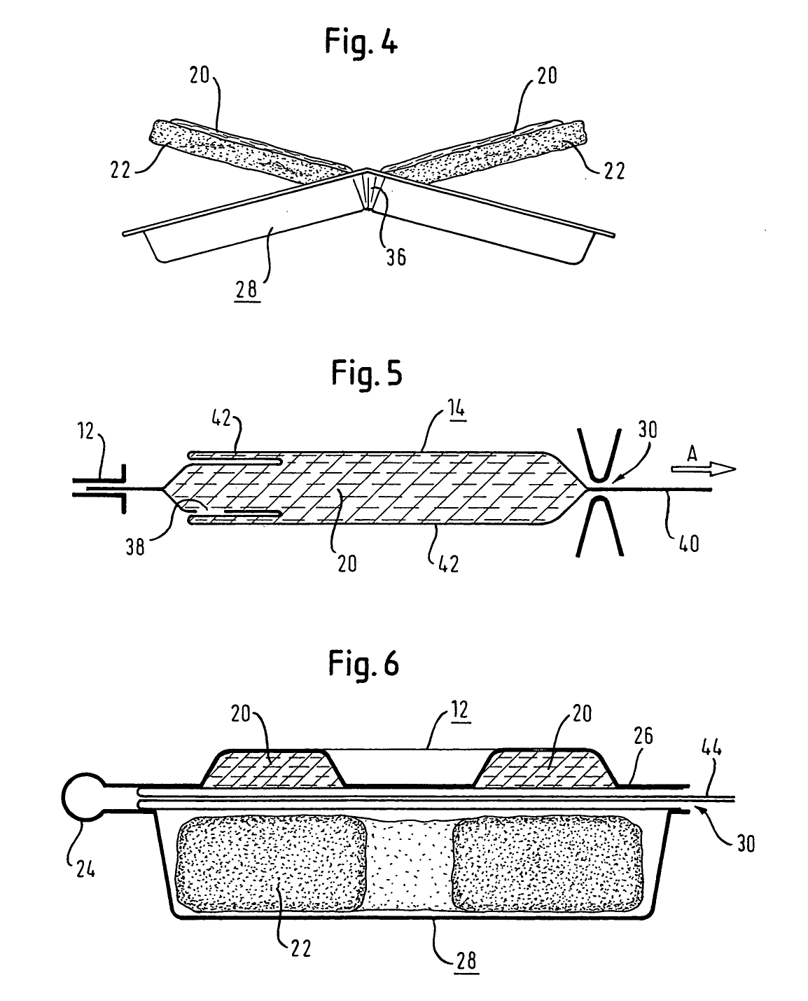

FIG. 4 shows a side view of a third embodiment of the inventive food product. Generally, this embodiment is similar to that of FIG. 3, in that two pieces of low moisture component 22, with the high moisture component 20 shown already spread on top of both of them, are provided. However, the base is formed with a flexible section 36, such as in the form of a bellow, in order to allow one section of the base 28 to be pivoted with regard to the other one. In the state shown in FIG. 4, one of the pieces of the low moisture component 22 rests on one section of the base 28, and the other one rests on the other section. Thus, each piece presents a section, which is easily graspable, as the underlying section of the base is pivotably hinged away. In summary, this embodiment provides the advantage of an easy removal of the combined food product.

In this context, it should be mentioned that that section of the base 28 which can be hinged with regard to the remainder of the base, can also be somewhat smaller. As an example, only a few centimeters from the end of the base could constitute this hingeable section so that this section can be lowered with regard to the remainder of the base so as to expose an easy to grasp end of each piece of the low moisture component. Furthermore, the hinge connection does not necessarily have to be provided in the form of a bellow. Rather, the sidewalls of the base could be breakable so that the hinge is formed by the bottom of the base. It can also be seen from FIG. 4, that the sections of the base 28 do not necessarily have to be moveable with regard to each other. Rather, almost the same effect is obtained if a recess is formed in at least a part of the bottom of the base 28, into which the piece of low moisture component 22 can be tilted so as to lift the piece of low moisture component at the opposite end and allow easy removal thereof. Such a recess can also be combined with a further recess in the vicinity of the piece of low moisture component, which allows the insertion of one or more fingers, which further facilitates the removal of the combined food product.

Several alternatives are conceivable for the inner package component 14 in which the high moisture component 20 is contained. FIG. 5 shows a non-limiting example of such an alternative. According to FIG. 5, the inner package component 14 is constituted by a pouch, which can be pulled through the constriction 30. The pouch contains at least one rolling seal, which covers an opening 38. One end of the pouch is held, e.g. by a portion of the outer shell 12. As can be seen from FIG. 5, pulling the pouch by its free end 40 in the direction of the arrow A, will cause the outer portion 42 to roll off from that portion of the pouch, on top of which it is laid in a “flat S”-like manner. By means of pulling the pouch in the direction of arrow A, the opening 38 is opened and the increased pressure due to the pouch being pulled through constriction 30, will cause the high moisture component 20 to exit the pouch through the opening 38. This causes the high moisture component 20 to be spread on top of the low moisture component (not shown in FIG. 5) in a similar manner as with the embodiments described above. It should be mentioned, that the pouch can also be provided without one or more rolling seals and can comprise a predetermined breaking point, such as in the form of a low adhesive seal instead. Moreover, the pouch does not necessarily have to be formed of flexible film or foil material alone. Rather, a rigid carrier can be provided which can comprise an opening, which is covered by a rolling seal. Attaching the material of the rolling seal, e.g. to the outer shell, will, in combination with removing the rigid carrier, expose the opening and again cause the content thereof to be spread on top of the low moisture component. That tag, which attaches the material of the rolling seal to the outer shell, at the inside thereof, can be formed so as to be releasable at the end of motion, so that the inner package component as a whole, including the mentioned tag can be removed from the outer shell.

A predetermined breaking point can, furthermore, be formed by means of a separate piece of film or foil material which covers an opening and is sealed to the pouch material in order to cause breaking thereof when a certain internal pressure is applied. Furthermore, the predetermined breaking point can be formed by means of one or more weakened areas or lines in the pouch material.

As an alternative, the tag forming the rolling seal could be provided so as to stay in the outer shell when the inner package component is removed therefrom.

FIG. 6 shows a schematic view of a fifth embodiment of the invention. Generally, as regards the outer shell 12 comprising a lid 26 and a base 28, as well as a hinge 24, the outer shell somewhat corresponds to that shown in FIG. 1. However, in the fifth embodiment the low moisture component 22 is provided in the shape of a bagel, which generally corresponds to the shape of a doughnut. For that reason, the base 28 is formed somewhat deeper. Moreover, in the embodiment of FIG. 6, the high moisture component 20 is sealed by means of a corporation between the lid 28 and an inner package component, which in this embodiment is constituted by a flexible film 44, which is folded back upon itself and thus forms a rolling seal.

Whereas this is not absolutely necessary, the embodiment shown in FIG. 6 comprises a second rolling seal. In principle, a compartment accommodating the high moisture component 20 is formed in the lid 26, and a compartment accommodating the low moisture component 22 is formed in the base 28. Each of these compartments is sealed by a flexible film. As can be seen in FIG. 6, the flexible film is folded back upon itself and extends out of the outer shell 12 and through the constriction 30. In other words, the flexible film covering the compartment of the base 28 is folded back on top of itself, whereas the flexible film covering the compartment of the lid 28 is folded underneath itself. Thus, the folded portions are adjacent to each other and each extend through the restriction 30.

When the product, according to FIG. 6, is to be consumed, a pulling force is applied to those portions, which extend out of the outer shell 12 and the flexible film is smoothly pulled from each of the compartments. Thus, both components of the food product are exposed and, if necessary, a slight pressure can be applied to the lid by means of which the partly rigid material of the lid can be deformed so as to help the high moisture component 20 to “fall onto” the low moisture component 22. Finally, the lid 28 can be opened and the combined product can be taken from the base 28. In this context, it should be mentioned that any of the above-mentioned features which were described with regard to other embodiments and particularly concerning easy removal of the combined food product, are also applicable to the embodiment of FIG. 6. Even further, any features of all embodiments of the invention can freely be combined with each other and are considered preferred embodiments of the invention.

1. A packaged food product, comprising:
a combined food product comprising at least one low moisture component, and at least one hermetically sealed high moisture component located on top of the low moisture component; and
a package comprising an outer shell and an inner package component,
wherein the inner package component is slidably removable through a constriction in the outer shell of the package so as to allow the high moisture component of the product to be spread on top of the low moisture component and to constitute an uppermost component of the combined food product.

2. The packaged food product of claim 1, wherein the outer shell of the package comprises at least one hinge.

3. The packaged food product of claim 2, wherein the inner package component comprises a flexible film.

4. The packaged food product of claim 3, wherein dimensions of the high moisture component correspond to or are smaller than dimensions of the low moisture component.

5. The packaged food product of claim 4, wherein the package comprises a portion protecting the inner package component from being accessed.

6. The packaged food product of claim 5, wherein the outer shell of the package comprises at least one recess in vicinity of the low moisture component for insertion of at least one finger in order to grip the low moisture component.

7. The packaged food product of claim 6, wherein the outer shell of the package comprises at least one hinged portion, which in a hingedly deflected state exposes at least a part of the low moisture component.

8. The packaged food product of claim 6, wherein the outer shell of the package comprises at least partly removable portion, which in at least partly removed state exposes at least a part of the low moisture component.

9. The packaged food product of claim 8, wherein the outer shell of the package comprises a recess underneath the low moisture component, which allows the low moisture component to be brought in at least partly lifted and easy to grasp state.

10. The packaged food product according to claim 9, wherein the inner package component comprises at least one predetermined breaking point.

11. The packaged food product of claim 10, wherein the inner package component comprises at least one rigid carrier.

12. The packaged food product of claim 11, wherein the inner package component comprises at least one rolling seal.

13. The packaged food product of claim 12, wherein the inner package component comprises two rolling seals, one rolling seal sealing the high moisture component and the other one sealing the low moisture component.

14. The packaged food product of claim 12, wherein the at least one low moisture component is substantially rectangular.

15. The packaged food product of claim 12, wherein the at least one low moisture component is substantially oval.

16. The packaged food product of claim 12, wherein the at least one low moisture component has a shape of a bagel or a doughnut.

17. The packaged food product of claim 12, wherein the low moisture component is a bread-type component, a wafer, a biscuit or any other dough-based component.

18. The packaged food product of claim 17, wherein the high moisture component is fresh cheese, processed cheese, a sandwich spread, a chocolate spread, or any other spreadable food component.

19. The packaged food product of claim 1, wherein the low moisture component is a bread-type component, a wafer, a biscuit or any other dough-based component.

20. The packaged food product of claim 1, wherein the high moisture component is fresh cheese, processed cheese, a sandwich spread, a chocolate spread, or any other spreadable food component
